(19) United States
(12) Patent Application Publication
(10) Pub. No.: US 2015/0363713 A1
(43) Pub. Date: Dec. 17, 2015

(54) SYSTEMS AND METHODS FOR EXTENDING FACTORY MANUFACTURING MODE TO NETWORKING DEVICES

(71) Applicant: Dell Products L.P., Round Rock, TX (US)

(72) Inventors: Jonathan Foster Lewis, Pflugerville, TX (US); Troy Allen Tiritilli, Round Rock, TX (US); Wei Liu, Austin, TX (US); Richard Brian Wallace, Pflugerville, TX (US)

(21) Appl. No.: 14/304,332

(22) Filed: Jun. 13, 2014

(51) Int. Cl. G06Q 10/06

(52) U.S. Cl. CPC G06Q 10/0631

(57) ABSTRACT

In accordance with embodiments of the present disclosure, an information handling system may include a processor, a first information handling resource communicatively coupled to the processor, and a second information handling resource for initializing one or more information handling resources of the information handling system. The second information handling resource may be configured to determine whether the information handling system is in a manufacturing mode and responsive to determining that the information handling system is in a manufacturing mode, expose an interface of the second information handling resource to the first information handling resource to enable the first information handling resource to perform one or more manufacturing mode-specific operations.

### TECHNICAL FIELD

The present disclosure relates in general to information handling systems, and more particularly to manufacturing and provisioning of information handling systems.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

To ensure positive customer experience, factory manufacturing of an information handling system usually includes extensive testing and configuration of the information handling system, to ensure operability of the information handling system, its various components, and the operating system and application programs installed thereon during the manufacturing process. Typical factory manufacturing processes for information handling systems suffer from many disadvantages and problems.

For example, to enable automation in the manufacturing of information handling systems, it is desirable that the information handling system be enabled to execute the Preboot Execution Environment (“PXE”), which is an environment allowing an information handling system to boot independently of data storage devices (like internal hard disks) or installed operating systems. Thus, in a “bare” information handling system without any software installed locally to the information handling system, PXE permits an information handling system to boot and execute software from a remote source in order to configure the information handling system (e.g., install operating systems, application programs, drivers, and configure for peripherals).

Furthermore, with rapid technology advancements with respect to speed of networked communications, oftentimes factory infrastructure does not have capacity in terms of available networking connections (e.g., optical networking connections) to meet the expected run-rate of many mainstream servers that have 1 Gigibit per second or higher rate networking ports installed in them. In addition, there exists a challenge to factory technicians to plug or otherwise couple a network cable to the networking port of the information handling system enabled for PXE, due to the fact that there are many different types of network cards each with different port topologies.

In existing factory manufacturing approaches, during the initial power-on self-test (POST) of the information handling system, once it has been determined that an information handling system is in a special manufacturing mode and which port of the network card needs to be enabled for PXE (e.g., a determination of which port of the network card has a cable plugged into it), initialization of the information handling system may have proceeded beyond the point at which PXE can be exposed to the scanning process of a basic input/output system (BIOS) option read-only memory (ROM), and thus a forced reboot may occur to enable PXE over the network-attached port. Such reboot may take a significant amount of time (e.g., 75 seconds) depending on system configuration, which adds to manufacturing time and thus adds to manufacturing cost of the information handling system.

### SUMMARY

In accordance with the teachings of the present disclosure, some of the disadvantages and problems associated with manufacturing an information handling system may be reduced or eliminated.

In accordance with embodiments of the present disclosure, an information handling system may include a processor, a first information handling resource communicatively coupled to the processor, and a second information handling resource for initializing one or more information handling resources of the information handling system. The second information handling resource may be configured to determine whether the information handling system is in a manufacturing mode and responsive to determining that the information handling system is in a manufacturing mode, expose an interface of the second information handling resource to the first information handling resource to enable the first information handling resource to perform one or more manufacturing mode-specific operations.

In accordance with these and other embodiments of the present disclosure, a method may include determining, by a first information handling resource of an information handling system, whether the information handling system is in a manufacturing mode. The method may also include responsive to determining that the information handling system is in a manufacturing mode, exposing an interface of the first information handling resource to a second information handling resource to enable the second information handling resource to perform one or more manufacturing mode-specific operations.

In accordance with these and other embodiments of the present disclosure, an article of manufacture may comprise a computer readable medium and computer-executable instructions carried on the computer readable medium. The instructions may be readable by a processor, the instructions, when read and executed, for causing the processor to determine, by a first information handling resource of an information handling system, whether the information handling system is in a manufacturing mode, and responsive to determining that the information handling system is in a manufacturing mode, expose an interface of the first information handling resource to a second information handling resource to enable the second information handling resource to perform one or more manufacturing mode-specific operations.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a block diagram of an example information handling system, in accordance with embodiments of the present disclosure; and

FIG. 2 illustrates a flow chart of an example method for extending a factory manufacturing mode to a network interface of an information handling system, in accordance with embodiments of the present disclosure.

### DETAILED DESCRIPTION

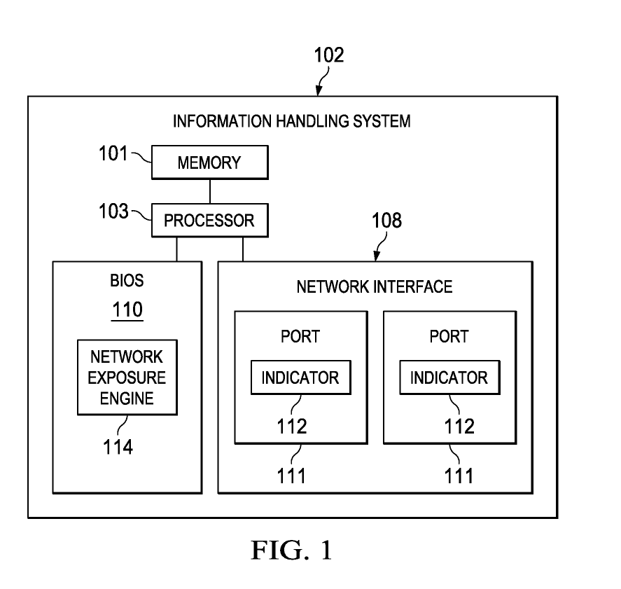

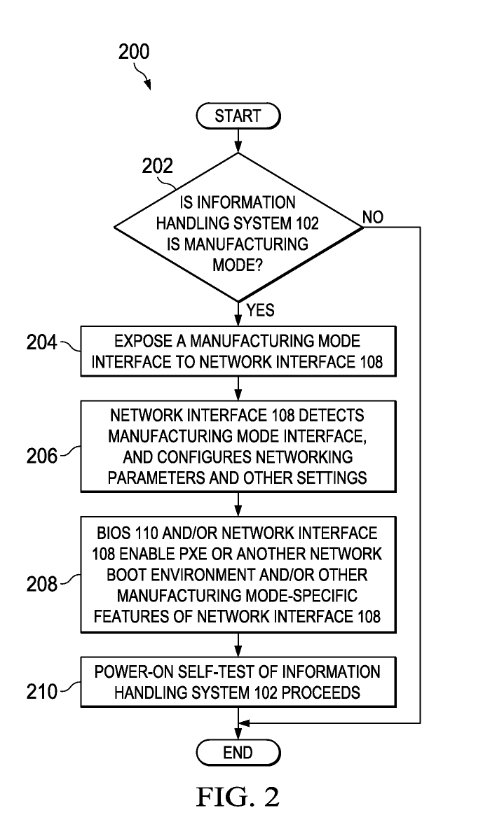

Preferred embodiments and their advantages are best understood by reference to FIGS. 1 and 2, wherein like numbers are used to indicate like and corresponding parts.

For the purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a personal digital assistant (PDA), a consumer electronic device, a network storage device, or any other suitable device and may vary in size, shape, performance, functionality, and price. The information handling system may include memory, one or more processing resources such as a central processing unit (“CPU”) or hardware or software control logic. Additional components of the information handling system may include one or more storage devices, one or more communications ports for communicating with external devices as well as various input/output (“I/O”) devices, such as a keyboard, a mouse, and a video display. The information handling system may also include one or more buses operable to transmit communication between the various hardware components.

For the purposes of this disclosure, computer-readable media may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; as well as communications media such as wires, optical fibers, microwaves, radio waves, and other electromagnetic and/or optical carriers; and/or any combination of the foregoing.

For the purposes of this disclosure, information handling resources may broadly refer to any component system, device or apparatus of an information handling system, including without limitation processors, service processors, basic input/output systems, buses, memories, I/O devices and/or interfaces, storage resources, network interfaces, motherboards, and/or any other components and/or elements of an information handling system.

FIG. 1 illustrates a block diagram of an example information handling system 102, in accordance with embodiments of the present disclosure. In some embodiments, information handling system 102 may be a personal computer. In some embodiments, information handling system 102 may comprise or be an integral part of a server. In other embodiments, information handling system 102 may be a portable information handling system (e.g., a laptop, notebook, tablet, handheld, smart phone, personal digital assistant, etc.). As depicted in FIG. 1, information handling system 102 may include a processor 103, a memory 104 communicatively coupled to processor 103, a network interface 108 communicatively coupled to processor 103, and a basic input/output system (BIOS) 110 communicatively coupled to processor 103.

Processor 103 may include any system, device, or apparatus configured to interpret and/or execute program instructions and/or process data, and may include, without limitation, a microprocessor, microcontroller, digital signal processor (DSP), application specific integrated circuit (ASIC), or any other digital or analog circuitry configured to interpret and/or execute program instructions and/or process data. In some embodiments, processor 103 may interpret and/or execute program instructions and/or process data stored in memory 104, BIOS 110, and/or another component of information handling system 102.

Memory 104 may be communicatively coupled to processor 103 and may include any system, device, or apparatus configured to retain program instructions and/or data for a period of time (e.g., computer-readable media). Memory 104 may include RAM, EEPROM, a PCMCIA card, flash memory, magnetic storage, opto-magnetic storage, or any suitable selection and/or array of volatile or non-volatile memory that retains data after power to information handling system 102 is turned off.

Network interface 108 may comprise any suitable system, apparatus, or device operable to serve as an interface between information handling system 102 and other information handling systems. Network interface 108 may enable information handling system 102 to communicate using any suitable transmission protocol and/or standard, including without limitation, Fibre Channel, Frame Relay, Asynchronous Transfer Mode (ATM), Internet protocol (IP), other packet-based protocol, small computer system interface (SCSI), Internet SCSI (iSCSI), Serial Attached SCSI (SAS) or any other transport that operates with the SCSI protocol, advanced technology attachment (ATA), serial ATA (SATA), advanced technology attachment packet interface (ATAPI), serial storage architecture (SSA), integrated drive electronics (IDE), and/or any combination thereof. In these and other embodiments, network interface 108 may comprise a network interface card, or “NIC.”

As shown in FIG. 1, network interface 108 may comprise a plurality of ports 111. Although FIG. 1 depicts network interface 108 as having two ports 111, network interface 108 may comprise any suitable number of ports 111. A port 111 may comprise any suitable physical interface whereby a network cable may be coupled to network interface 108 in order to communicatively couple network interface 108 to a communication network. As depicted in FIG. 1, each port 111 may also include an indicator 112. Indicator 112 may comprise any system, device, or apparatus (e.g., a light-emitting diode) configured to provide a human-perceptible indication (e.g., light) of a status of its respective port 111. For example, an indicator 112 may illuminate to indicate PXE or another network boot environment is enabled on its respective port 111.

BIOS 110 may be communicatively coupled to processor 103 and may include any system, device, or apparatus configured to identify, test, and/or initialize information handling resources of information handling system 102. “BIOS” may broadly refer to any system, device, or apparatus configured to perform such functionality, including without limitation, a Unified Extensible Firmware Interface (UEFI). In some embodiments, BIOS 110 may be implemented as a program of instructions that may be read by and executed on processor 103 to carry out the functionality of BIOS 110. In these and other embodiments, BIOS 110 may comprise boot firmware configured to be the first code executed by processor 103 when information handling system 102 is booted and/or powered on. As part of its initialization functionality, BIOS code may be configured to set components of information handling system 102 into a known state, so that one or more applications (e.g., an operating system or other application programs) stored on compatible media (e.g., memory 104) may be executed by processor 103 and given control of information handling system 102.

As shown in FIG. 1, BIOS 110 may include network exposure engine 114. As described in greater detail elsewhere in this disclosure, network exposure engine 114 may include any system, device, or apparatus configured to, as described in greater detail elsewhere in this disclosure, expose a manufacturing mode interface of BIOS 110 to network interface 108, thus enabling PXE or another remote network boot environment and enabling other manufacturing mode-specific features of network interface 108. In some embodiments, network exposure engine 114 may be implemented as a program of instructions that may be read by and executed on processor 103 to carry out the functionality of network exposure engine 114.

In addition to processor 103, memory 104, network interface 108, and BIOS 110, information handling system 102 may include one or more other information handling resources.

In operation, information handling system 102 may be configured to operate in a manufacturing mode during installation, manufacturing, and testing of information handling system 102. Existing in such manufacturing mode may be indicated by a variable or flag set in BIOS 110, and at some point during the manufacturing process, such variable or flag may be changed such that information handling system 102 does not remain in the manufacturing mode when delivered to the end user. Upon detecting that information handling system 102 is in such manufacturing mode, network exposure engine 114 may expose a generic network interface-agnostic interface in which any network interface hardware from any vendor may interface with BIOS 110 which may enable PXE or another remote network boot environment and/or enable other manufacturing mode-specific features of network interface 108. Such interface may provide necessary information for network interface 108 to execute such manufacturing mode-specific features, such as parameters associated with network interface 108 (e.g., an identifier or other parameter associated with network interface 108).

FIG. 2 illustrates a flow chart of an example method 200 for extending a factory manufacturing mode of information handling system 102 to network interface 108 of information handling system 102. According to some embodiments, method 200 may begin at step 202. As noted above, teachings of the present disclosure may be implemented in a variety of configurations of information handling system 102. As such, the preferred initialization point for method 200 and the order of the steps comprising method 200 may depend on the implementation chosen.

At step 202, after information handling system 102 is powered on, network exposure engine 114 may execute and determine if information handling system 102 is in the manufacturing mode. If information handling system 102 is in the manufacturing mode, method 200 may proceed to step 204. Otherwise, method 200 may proceed to step 210.

At step 204, in response to determining that information handling system 102 is in the manufacturing mode, network exposure engine 114 may expose a manufacturing mode interface to network interface 108. In some embodiments of the present disclosure, such interface may be a BIOS-published variable or function (e.g., an INT15 function). At step 206, network interface 108 may detect the manufacturing mode interface, and configure its networking parameters and other settings appropriately. At step 208, BIOS 110 and network interface 108 may, alone or in concert, enable PXE or another network boot environment and/or other manufacturing mode-specific features of network interface 108 (e.g., illuminating indicator 112 of port 111 enabled for PXE or another network boot environment).

At step 210, power-on self-test of information handling system 102 may proceed. After completion of step 210, method 200 may end.

Although FIG. 2 discloses a particular number of steps to be taken with respect to method 200, method 200 may be executed with greater or fewer steps than those depicted in FIG. 2. In addition, although FIG. 2 discloses a certain order of steps to be taken with respect to method 200, the steps comprising method 200 may be completed in any suitable order.

Method 200 may be implemented using information handling system 102 or any other system operable to implement method 200. In certain embodiments, method 200 may be implemented partially or fully in software and/or firmware embodied in computer-readable media.

In some embodiments of the present disclosure, the functionality attributed to BIOS 110 may be performed all or in part by another information handling resource of information handling system 102. For example, in some embodiments, such functionality may be performed by a baseboard management controller (e.g., a Dell Remote Access Controller or an Integrated Dell Remote Access Controller) which may couple to network interface 108 or another information handling system via a sideband interface (e.g., Network Controller Sideband Interface or “NC-SI.”).

Although the foregoing discussion contemplates extension of a manufacturing mode of an information handling system to a network interface, the methods and systems described herein are not limited to application to network interfaces. Accordingly, methods and systems similar and analogous to those described herein may be applied to information handling resources other than network interfaces.

Although the present disclosure has been described in detail, it should be understood that various changes, substitutions, and alterations can be made hereto without departing from the spirit and the scope of the disclosure as defined by the appended claims.

What is claimed is:

1. An information handling system comprising:
a processor;
a first information handling resource communicatively coupled to the processor; and
a second information handling resource for initializing one or more information handling resources of the information handling system, wherein the second information handling resource is configured to:
determine whether the information handling system is in a manufacturing mode; and
responsive to determining that the information handling system is in a manufacturing mode, expose an interface of the second information handling resource to the first information handling resource to enable the first information handling resource to perform one or more manufacturing mode-specific operations.

2. The information handling system of claim 1, wherein the first information handling resource comprises a network interface and the interface of the second information handling resource exposes parameters for enabling the network interface to perform the one or more manufacturing mode-specific operations.

3. The information handling system of claim 2, wherein the one or more manufacturing mode-specific operations comprises a network boot environment via a port of the network interface.

4. The information handling system of claim 3, wherein the one or more manufacturing mode-specific operations comprises causing an indicator associated with the port to indicate that the port is enabled for the network boot environment.

5. The information handling system of claim 1, wherein the second information handling resource comprises a basic input/output system (BIOS) comprising a program of instructions executable by the processor and configured to cause the processor to initialize one or more information handling resources of the information handling system, wherein the BIOS is further configured to, responsive to determining that the information handling system is in a manufacturing mode, expose an interface of the BIOS to the first information handling resource to enable the first information handling resource to perform the one or more manufacturing mode-specific operations.

6. The information handling system of claim 1, wherein the second information handling resource comprises a baseboard management controller configured to cause the processor to initialize one or more information handling resources of the information handling system, wherein the baseboard management controller is further configured to, responsive to determining that the information handling system is in a manufacturing mode, expose an interface of the baseboard management controller to the first information handling resource via a sideband interface of the first information handling resource to enable the first information handling resource to perform the one or more manufacturing mode-specific operations.

7. A method comprising:
determining, by a first information handling resource of an information handling system, whether the information handling system is in a manufacturing mode; and
responsive to determining that the information handling system is in a manufacturing mode, exposing an interface of the first information handling resource to a second information handling resource to enable the second information handling resource to perform one or more manufacturing mode-specific operations.

8. The method of claim 7, wherein the second information handling resource comprises a network interface and exposing the interface comprises exposing, by the first information handling resource, parameters for enabling the network interface to perform the one or more manufacturing mode-specific operations.

9. The method of claim 8, wherein the one or more manufacturing mode-specific operations comprises a network boot environment via a port of the network interface.

10. The method of claim 9, wherein the one or more manufacturing mode-specific operations comprises causing an indicator associated with the port to indicate that the port is enabled for the network boot environment.

11. The method of claim 7, wherein the first information handling resource comprises a basic input/output system (BIOS) comprising a program of instructions executable by a processor of the information handling system and configured to cause the processor to initialize one or more information handling resources of the information handling system, wherein the BIOS is further configured to, responsive to determining that the information handling system is in a manufacturing mode, expose an interface of the BIOS to the second information handling resource to enable the second information handling resource to perform the one or more manufacturing mode-specific operations.

12. The method of claim 7, wherein the first information handling resource comprises a baseboard management controller configured to cause the processor to initialize one or more information handling resources of the information handling system, wherein the baseboard management controller is further configured to, responsive to determining that the information handling system is in a manufacturing mode, expose an interface of the baseboard management controller to the second information handling resource via a sideband interface of the second information handling resource to enable the second information handling resource to perform the one or more manufacturing mode-specific operations.

13. An article of manufacture comprising:
a computer readable medium; and
computer-executable instructions carried on the computer readable medium, the instructions readable by a processor, the instructions, when read and executed, for causing the processor to:
determine, by a first information handling resource of an information handling system, whether the information handling system is in a manufacturing mode; and
responsive to determining that the information handling system is in a manufacturing mode, expose an interface of the first information handling resource to a second information handling resource to enable the second information handling resource to perform one or more manufacturing mode-specific operations.

14. The article of claim 13, wherein the second information handling resource comprises a network interface and exposing the interface comprises exposing, by the first information handling resource, parameters for enabling the network interface to perform the one or more manufacturing mode-specific operations.

15. The article of claim 14, wherein the one or more manufacturing mode-specific operations comprises a network boot environment via a port of the network interface.

16. The article of claim 15, wherein the one or more manufacturing mode-specific operations comprises causing an indicator associated with the port to indicate that the port is enabled for the network boot environment.

17. The article of claim 13, wherein the first information handling resource comprises a basic input/output system (BIOS) comprising a program of instructions executable by a processor of the information handling system and configured to cause the processor to initialize one or more information handling resources of the information handling system, wherein the BIOS is further configured to, responsive to determining that the information handling system is in a manufacturing mode, expose an interface of the BIOS to the second information handling resource to enable the second information handling resource to perform the one or more manufacturing mode-specific operations.

18. The article of claim 13, wherein the first information handling resource comprises a baseboard management controller configured to cause the processor to initialize one or more information handling resources of the information handling system, wherein the baseboard management controller is further configured to, responsive to determining that the information handling system is in a manufacturing mode, expose an interface of the baseboard management controller to the second information handling resource via a sideband interface of the second information handling resource to enable the second information handling resource to perform the one or more manufacturing mode-specific operations.
